(19) United States
(12) Patent Application Publication
(10) Pub. No.: US 2010/0167977 A1
(43) Pub. Date: Jul. 1, 2010

(54) CLOTHES WASHING PRODUCT

(76) Inventor: Albert Infantes, Barcelona (ES)

Correspondence Address: KANE & CO., PLC, 29 PEARL ST. NW, 410 FEDERAL SQUARE BUILDING, GRAND RAPIDS, MI, 49503, US

(21) Appl. No.: 12/529,000

(22) PCT Filed: Feb. 25, 2008
(86) PCT No.: PCT/ES2008/000103

§ 371 Date: Mar. 16, 2010

(30) Foreign Application Priority Data
Feb. 28, 2007 (ES) P200700532

(51) Int. Cl. C11D 3/34; C11D 3/00; C11D 3/42

(52) U.S. Cl. 510/343; 510/276; 510/513; 510/516; 510/528

(57) ABSTRACT

The invention relates to a clothes washing product. According to the invention, a solar ultraviolet, radiation filtering substance is added to the conventional composition of a clothes washing product, such as a softener, detergent (structured or non-structured liquid, powder or tablets), pre-wash products, stain removers, scale removers, whiteners or any other additive. Consequently, with each wash, the ultraviolet radiation filtering substance is deposited on the clothes, forming a barrier thereon that protects the wearer's skin from harmful radiation, the cumulative effects of which can be serious.

### OBJECT OF THE INVENTION

The present invention relates to a new product, of those used in clothes washing, among which the softener, the detergent (structured or non-structured liquid, powder or tablets), pre-wash products, stain removers, scale removers, whiteners or any other additive are included.

The object of the invention is to achieve a product which, in parallel with or independently of its classic function as a component used in clothes washing, provides it with a barrier effect against ultraviolet rays, protecting the wearer thereof from the harmful effects of solar radiation.

The invention is therefore located in the field of chemical formulations intended for clothes washing.

### BACKGROUND OF THE INVENTION

As is known, rays of sunlight pass through garments to a greater or lesser extent, causing reactions in the skin, some of them with a cumulative effect, such that in the long run they cause health problems which can be extremely serious.

There are products which act as a solar ultraviolet radiation filter, which products are commercialized in the form of creams to be directly applied on the skin. Moreover, there are different products which offer different levels of protection, depending on the personal characteristics of the users, on the radiation level existing at the time of their use, on the expected periods of exposure to the sun, etc.

These creams are fully efficient when they are used in the manner in which they have been provided, i.e., when they are applied on the bare skin exposed to the sun, but they do not fulfill their function (because they are not applied) when the user is dressed, on one hand due to the fact that most people think that when their body is covered with a garment, however light it is, they are protected from solar radiation, under a garment makes the latter adhere to the body, its use being extremely uncomfortable.

In addition, textile articles offering properties of protection against ultraviolet radiation are known; thus, for example, when referring to making garments based on synthetic fibers, the addition of substances during the polymerization of the fiber to enhance the blocking effect against the ultraviolet radiation of sunlight is known. However, this solution involves having to foresee at the outset the specific application of the garments, which very considerably complicates both the industrial and the commercial process, and furthermore the fibers gradually lose their effectiveness as such a barrier effect over time. This functional degradation of the fabric occurs not only in the washing but also in dry cleaning.

### DESCRIPTION OF THE INVENTION

The clothes washing product proposed by the invention fully and satisfactorily solves the aforementioned problem, such that without affecting at all the conditions of use of any garment, it provides the latter with a barrier effect against ultraviolet rays, eliminating the negative consequences of said radiation on the skin.

The product can be formed as a softener, a detergent (structured or non-structured liquid, powder or tablets) or any other additive participating in a clothes washing operation.

To that end and more specifically, said product focuses its features on incorporating to its formulation an ultraviolet radiation filtering substance, in proportions suitable for achieving the sought barrier effect in the garment by duly impregnating the fabric thereof.

In the specific case in which the product consists of a softener, said product has the following type of formulation, in percentages expressed by weight:
Deionized water in a proportion comprised between 60% and 90%.
Ultraviolet ray filtering substance in a proportion comprised between 10% and 20%.
Softening substance in a proportion comprised between 3% and 12%.
Surfactant in a proportion comprised between 0.0% and 1.7%.
Perfume in a proportion comprised between 0.5% and 1.2%.
Thickener in a proportion comprised between 0.0% and 0.8%.
Colorant in a proportion comprised between 0.0% and 0.9%.
Preservative in a proportion comprised between 0.0% and 0.6%.

The described softening substance provides the product with the classic and conventional effect of any softener for clothes, duly aromatized with the perfume in suitable conditions by means of incorporating the thickener and the preservative, whereas the ultraviolet ray filter substance is fixed in the fabrics homogeneously distributed due to the effect of the washing and provides the filtering effect to the garment as a whole, maintaining its operative features until a there is a new wash and consequently a new supply of the UV filter substance.

Moreover, after each wash and more specifically after each period of use of the garment, a certain amount of ultraviolet ray filtering substance remains therein, on which the amount provided in the next wash is accumulated, such that the ray filtering effect in a garment progressively increases over time with the use of the softener of the invention.

In the specific case in which the product consists of a liquid detergent, said product has the following type of formulation, in percentages expressed by weight:
Deionized water in a proportion comprised between 20% and 80%.
Detergent agent in a proportion comprised between 0.0% and 40%.
Emulsifier in a proportion comprised between 1.0% and 20%.
Surfactant in a proportion comprised between 1.0% and 45.0%.
Ultraviolet ray filtering substance in a proportion comprised between 0.3% and 5.0%.
Fluidifying agent in a proportion comprised between 0% and 30%.
Thickener in a proportion comprised between 0.2% and 3.0%.
Opacifying agent in a proportion comprised between 0.0% and 2.0%.
Preservative in a proportion comprised between 0.0% and 1.0%.
Enzymes in a proportion comprised between 0.0% and 1.0%.
pH regulator in a proportion comprised between 0.0% and 2.0%.
Colorant in a proportion comprised between 0.0% and 0.9%.
Perfume in a proportion comprised between 0.1% and 0.9%.

In the specific case in which the product consists of a powder detergent, said product has the following type of formulation, in percentages expressed by weight:
Inert filler in a proportion comprised between 0.0% and 60%.
Surfactant in a proportion comprised between 5.0% and 35%.
Soaps or foam regulators in a proportion comprised between 0.0% and 5.0%.
Coadjuvants in a proportion comprised between 0.0% and 45%.
Ultraviolet ray filtering substance in a proportion comprised between 0.3% and 5.0%.
Water hardness reducer in a proportion comprised between 0.0% and 40%.
pH regulator in a proportion comprised between 0.0% and 20%.
Anti-redeposition agent in a proportion comprised between 0.0% and 5.0%.
Dispersant and sequestrant in a proportion comprised between 0.0% and 6.0%.
Whitener in a proportion comprised between 0.0% and 25%.
Whitener activating agent in a proportion comprised between 0.0% and 6.0%.
Descaling agent in a proportion comprised between 0.0% and 25%.
Dyeing inhibitor in a proportion comprised between 0.0% and 2.0%.
Enzymes in a proportion comprised between 0.0% and 1.5%.
pH regulator in a proportion comprised between 0.0% and 20%.
Colorant in a proportion comprised between 0.0% and 0.2%.
Perfume in a proportion comprised between 0.1% and 0.5%.
Optical brightener in a proportion comprised between 0.1% and 0.5%.

### PRACTICAL EMBODIMENT OF THE INVENTION

In a practical embodiment of the invention the following components with the following proportions by weight were used.
Deionized water 77.8%.
UV filter 12%.
Softening substance 8%.
Perfume 1%
Thickener 0.7%.
Preservative 0.5%.

A stilbenedisulfonic acid triazine can be used specifically as a UV filter, i.e., as an ultraviolet ray filtering substance.

As a softening substance and within the wide variety of chemical products with this property, the most used ones are among the quaternary ammonium salts (esters) of fatty acids. In the present case the use of carboxylic acid esters of animal and plant origin, and methyl triethanol ammonium methyl sulfate dialkyl ester has been provided.

The use of a wide range of substances from the family of alcohols and aldehydes, mainly hexyl cinnamal, citronellol, geraniol, benzyl benzoate, isomethyl ionone, linalool, coumarin or eugenol has been provided as perfume.

Parabens or 4-hydroxybenzoic acid esters are commonly used against the risk of antimicrobial growth and as preservative substances, the incorporation of a mixture of several parabens and phenoxyethanol having been provided in the present case.

The results are obtaining an optimal barrier effect against UV rays in the clothes washed with the softener of the invention, and consequently an optimal degree of protection for the wearer's skin located underneath said clothes.

In another practical embodiment of the invention the following components with the following proportions by weight were used:
Water hardness reducer 20.14%
Whitener 18.0%
Coadjuvants 16.25%
Surfactant 15.7%
pH regulator 8.35%
Inert filler 6.905%
Descaling agent 4.0%
Dispersant and sequestrant 3.15%
UV filter 2.54%
Soap or foam regulator 1.72%
Enzymes 1.23%
Anti-redeposition agent 1.13%
Perfume 0.4%
Whitener activating agent 0.2%
Optical brightener 0.27%
Colorant 0.015%

A diamino stilbenedisulfonic compound can be used specifically as a UV filter, i.e., as an ultraviolet ray filtering substance.

As a water hardness reducer and within the wide variety of chemical products with this property, the most used ones are among zeolites, sodium tripolyphosphates, the sodium salts of ethylenediaminetetraacetic acid, of nitrilotriacetic acid and of citric acid, as well as certain phosphates. In the present case the use of crystalline water-insoluble sodium aluminosilicates has been provided.

Sodium permanganates and perborates are generally used as a whitener. In the present case sodium perborate has been used.

Sodium tripolyphosphate, sodium silicate and phosphates have been used as coadjuvants, with the function of enhancing the effect of the surfactants.

The most used surfactants in formulations of detergents are anionic surfactants, especially linear alkylbenzene sulfonates, alkyl ether sulfates and fatty alcohol sulfates. Nonionic surfactants, used in lower proportion, are mainly fatty alcohol ethoxylates or fatty acid alkanolamides. Cationic surfactants are compounds the molecules in solution of which are dissociated, the active group being positively charged (cation), mainly being used in softeners for clothes. Amphoteric surfactants are not much used as raw materials for detergents. Only certain liquid formulations incorporate them as additives for conferring specific properties. Alkylbenzene sulfonates and lauryl alcohol ethoxylate have been used in the particular case of this example.

Soda, carbonates, bicarbonates and citrates are usually used as a pH regulator. In this particular case sodium carbonate has been used.

The inert filler which is most common and which has been used in the present formula is sodium sulfate, which improves the physical properties of the detergent: appearance, fluidity and anti-caking.

The descaling agent used in this embodiment has been sodium citrate. Sulfamic acid salts are also usually used.

Polycarboxylates (polymers and copolymers of polycarboxylic and/or hydroxypolycarboxylic acids and their salts) and polymers and copolymers derived from maleic, acrylic and/or styrenic acids are the most used as dispersants. In the present case several polycarboxylates which furthermore fulfill the function of sequestrants have been used.

Sodium salts of different fatty acids, with chain lengths from C12 to C22, which in addition to contributing to the washing process act with great efficacy as foam regulators, are used as soaps. In the present embodiment coco salts and palmitates have been used.

The most used enzymes in detergents are proteases, for the purpose of eliminating the protein stains which would otherwise be much more difficult to clean from the clothes. Other enzymes, used in lower proportion, are amylases, lipases and cellulases. In the present embodiment lipases and proteases have been used.

The most used anti-redeposition agent, and also the one used in this case, is sodium carboxymethylcellulose.

The use of a wide range of substances from the family of alcohols and aldehydes, mainly hexyl cinnamal, citronellol, geraniol, benzyl benzoate, isomethyl ionone, linalool, coumarin or eugenol has been provided as perfume.

The whitener activating agents are substances which, mixed with the oxygen releasing whiteners, are used to activate the giving-off of oxygen during the washing at low temperatures, even at room temperature, to increase the effectiveness of the whitening. The most commonly used product, and also the one used in this case, is TAED (tetraacetylethylenediamine).

Optical brighteners serve to achieve an additional whitening effect of the fabrics. In most cases, and also in the present case, they are sulfonated distyrylbiphenyl compounds.

As in the case of the softener, the results are obtaining an optimal barrier effect against UV rays in the clothes washed with the detergent of the invention, and consequently an optimal degree of protection for the wearer's skin located underneath said clothes.

1. A clothes washing product, which, being able to he formed as a softener, a detergent (structured or non-structured liquid, powder or tablets), a pre-wash product, a stain remover, a scale remover, a whitener or any other additive used in washing, is characterized in that it further incorporates a solar ultraviolet radiation filtering substance, in order to prevent the passage of said radiation towards the wearer's skin through the clothes.

2. The clothes washing product according to claim 1, characterized in that when it is formed as a softener, the components participating therein do so with the following proportions by weight:
deionized water in a proportion comprised between 60% and 90%:
an ultraviolet radiation filtering substance in a proportion comprised between 10% and 20%;
a softening substance in a proportion comprised between 3% and 12%;
a surfactant in a proportion comprised between 0.0% and 1.7%;
a perfume in a proportion comprised between 0.5% and 1.2%;
a thickner in a proportion comprised between 0.0% and 0.8%;
a colorant in a proportion comprised between 0.0% and 0.9%; and
preservative in a proportion comprised between 0.0% and 0.6%.

3. The clothes washing product according to claim 2, characterized in that the ultraviolet radiation filter is a stilbenedisulfonic acid triazine.

4. The clothes washing product according to claim 1, characterized in that when it is a liquid detergent the components participating therein do so with the following proportions by weight:
a deionized water in a proportion comprised between 20% and 80%;
a detergent agent in a proportion comprised between 0.0% and 40%;
an emulsifier in a proportion comprised between 1.0% and 20%;
a surfactant in a proportion comprised between 1.0% and 45.0%;
an ultraviolet radiation .filtering substance in a proportion comprised between 0.3% and 5.0%;
a fluidifying agent in a proportion comprised between 0% and 30%;
a thickener in a proportion comprised between 0.2% and 3.0%;
an opacifying agent in a proportion comprised between 0.0% and 2.0%;
a preservative in a proportion comprised between 0.0% and 1.0%;
at least one enzymes in a proportion comprised between 0.0% and 1.0%;
a pH regulator in a proportion comprised between 0.0% and 2.0%;
a colorant in a proportion comprised between 0.0% and 0.9%; and
a perfume in a proportion comprised between 0.1% and 0.9%.

5. The clothes washing product according to claim 4, characterized in that the ultraviolet radiation filter is a diamino stilbenedisultbnic compound.

6. The clothes washing product according to claim 1, characterized in that when it is a powder detergent the components participating therein do so with the following proportions by weight:
an inert filler in a proportion comprised between 0.0% and 60%;
a surfactant in a proportion comprised between 5.0% and 35%;
one of a soap and foam regulator in a proportion comprised between 0.0% and 5.0%;
a coadjuvant in a proportion comprised between 0.0% and 45%;
an ultraviolet radiation filtering substance in a proportion comprised between 0.3% and 5.0%;
a water hardness reducer in a proportion comprised between 0.0% and 40%;
a pH regulator in a proportion comprised between 0.0% and 20%;
an anti-redeposition agent in a proportion comprised between 0.0% and 5.0%;
a dispersant and sequestrant in a proportion comprised between 0.0% and 6.0%;
a whitener in a proportion comprised between 0.0% and 25%;
a whitener activating agent in a proportion comprised between 0.0% and 6.0%;
a descaling agent in a proportion comprised between 0.0% and 25%;
a dyeing inhibitor in a proportion comprised between 0.0% and 2.0%;
enzymes in a proportion comprised between 0.0% and 1.5%;
a pH regulator in a proportion comprised between 0.0% and 20%;
a colorant in a proportion comprised between 0.0% and 0.2%; and
a perfume in a proportion comprised between 0.1% and 0.5%; and an optical brightener in a proportion comprised between 0.1% and 0.5%.

7. The clothes washing product according to claim 6, characterized in that the ultraviolet radiation filter is a diamino stilbenedisulfonic compound.

8. A clothes washing product in the form of a softener, a detergent (structured or non-structured liquid, powder or tablets), a pre-wash product, a stain remover, a scale remover, a whitener or any other additive used in washing, comprising a solar ultraviolet radiation filtering substance for reducing the passage of ultraviolet radiation through the clothes to the wearer's skin.

9. The clothes washing product according to claim 8, wherein the product is a softener comprises the ingredients: deionized water in a proportion ranging from about 60% and about 90%; an ultraviolet radiation filtering substance in a proportion ranging from about 10% to about 20%; a softening substance in a proportion ranging from about 3% to about 12%; a surfactant in a proportion ranging from about 0.0% to about 1.7%; a perfume in a proportion ranging from about 0.5% to about 1.2%; a thickener in a proportion ranging from about 0.0% to 0.8%; a colorant in a proportion ranging from about 0.0% to about 0.9% and a preservative in a proportion ranging from about 0.0% to about 0.6%.

10. The clothes washing product according to claim 9 wherein said ultraviolet radiation filtering substance includes stilbenedisulfonic acid triazine.

11. The clothes washing product according to claim 8, wherein the product includes a liquid detergent comprises the ingredients: de-ionized water in a proportion ranging from about 20% to about 80%; a detergent agent in a proportion ranging from about 0.0% to about 40%; an emulsifier in a proportion ranging from about 1.0% to about 20%; a surfactant in a proportion ranging from about 1.0% to about 45.0%; an ultraviolet radiation filtering substance in a proportion ranging from about 0.3% to about 5.0%; a fluidifying agent in a proportion ranging from about 0% to about 30%; a thickener in a proportion ranging from about 0.2% to about 3.0%; an opacifying agent in a proportion ranging from about 0.0% to about 2.0%; a preservative in a proportion ranging from about 0.0% to about 1.0%; at least one enzyme in a proportion ranging from about 0.0% to about 1.0%; a pH regulator in a proportion ranging from about 0.0% to about 2.0%; a colorant in a proportion ranging from about 0.0% to about 0.9%; and a perfume in a proportion ranging from about 0.1% to about 0.9%.

12. The clothes washing product according to claim 11, wherein said ultraviolet radiation filter includes a diamino stilbenedisuffonic compound.

13. The clothes washing product according to claim 8, wherein the powder detergent comprises the ingredients: inert filler in a proportion comprised between 0.0% and 60%; a surfactant in a proportion comprised between 5.0% and 35%; one of a soap and foam regulator in a proportion comprised between 0.0% and 5.0%; a coadjuvants in a proportion comprised between 0.0% and 45%; an ultraviolet radiation filtering substance in a proportion comprised between 0.3% and 5.0%; a water hardness reducer in a proportion comprised between 0.0% and 40%; a pH regulator in a proportion comprised between 0.0% and 20%; an anti-redeposition agent in a proportion comprised between 0.0% and 5.0%; one of a dispersant and sequestrant in a proportion comprised between 0.0% and 6.0%; a whitener in a proportion comprised between 0.0% and 25%; a whitener activating agent in a proportion comprised between 0.0% and 6.0%; a descaling agent in a proportion comprised between 0.0% and 25%; a dyeing inhibitor in a proportion comprised between 0.0% and 2.0%; at least one enzyme in a proportion comprised between 0.0% and 1.5%; a colorant in a proportion comprised between 0.0% and 0.2%; a perfume in a proportion comprised between 0.1% and 0.5%; and an optical brightener in a proportion comprised between 0.1% and 0.5%.

14. The clothes washing product according to claim 13, wherein said ultraviolet radiation filter includes a diamino stilbenedisulfonic compound.

15. A clothes washing compound comprising an ultraviolet radiation filtering compound.

16. The clothes washing compound as defined in claim 15, where said ultraviolet radiation filtering compound includes a diamino stilbenedisulfonic compound.

17. The ultraviolet radiation filtering compound as defined in claim 16, wherein said diamino stilbenedisulfonic compound includes stilbenedisulfonic acid triazine.
